(19) United States
(12) Patent Application Publication
(10) Pub. No.: US 2026/0316636 A1
(43) Pub. Date: Oct. 15, 2026

(54) APPARATUS AND METHOD FOR CONTROLLING VEHICLE

(71) Applicant: HYUNDAI MOBIS CO., LTD., Seoul (KR)

(72) Inventors: Tae Hun KIM, Yongin-si (KR); Joo Hey HONG, Yongin-si (KR)

(73) Assignee: HYUNDAI MOBIS CO., LTD., Seoul (KR)

(21) Appl. No.: 19/531,806

(22) Filed: Feb. 6, 2026

(30) Foreign Application Priority Data
Apr. 15, 2025 (KR) 10-2025-0048908

(51) Int. Cl. B60N 2/02

(52) U.S. Cl. CPC B60N 2/0273; B60N 2/0268

(57) ABSTRACT

An apparatus for controlling a vehicle may comprise: a posture sensing unit configured to sense a posture of a user of the vehicle; a driving state determining unit configured to determine a driving state of the vehicle; and a seat control unit configured to control at least a part of a seat of the vehicle based on at least one of the sensed posture of the user or the driving state.

### CROSS-REFERENCE TO RELATED PATENT APPLICATION

This application claims the benefit of Korean Patent Application No. 10-2025-0048908, filed on Apr. 15, 2025, in the Korean Intellectual Property Office, the disclosure of which is incorporated herein in its entirety by reference.

### TECHNICAL FIELD

An embodiment of the present disclosure relates to an apparatus and a method for controlling a vehicle, and more particularly, to a method for improving physical stability in a vehicle.

### BACKGROUND

In recent years, various vehicle apparatuses have been provided for the convenience of a driver or an occupant.

When a driver or an occupant(s) does not fasten a seat belt while a vehicle is being driven, an alarm may be provided to guide fastening of the seat belt, and when a driver is seated on a seat, the seat may be moved by pressing a button.

In addition, the vehicle may be provided with various sensors for convenience for a user of the vehicle, such as a driver or an occupant.

However, such technologies may cause a lot of problems, and accordingly a method for improving physical stability is proposed herein in order to solve such problems.

### SUMMARY

An apparatus for controlling a vehicle according to one embodiment may include: a posture sensing unit configured to sense a posture of a user of the vehicle; a driving state determining unit configured to determine a driving state of the vehicle; and a seat control unit configured to control at least a portion of a seat of the vehicle based on at least one of the sensed posture of the user or the driving state.

The posture sensing unit according to one embodiment may determine whether the sensed posture corresponds to a stretching posture of the user.

When the sensed posture of the user is determined to be the stretching posture, the seat control unit according to one embodiment may control an operation of the seat to support the user in performing a stretching movement.

The driving state determining unit according to one embodiment may determine whether the driving state is a stopped state or a state prior to driving.

When the driving state of the vehicle is determined to be the stopped state, the seat control unit according to one embodiment may control an operation of the seat to cause movement of at least a portion of the seat, or when the driving state of the vehicle is determined to be the state prior to driving, the seat control unit may control an operation of the seat to restore the at least a portion of the seat to a previous position.

A method for controlling a vehicle according to one embodiment may include: sensing a posture of a user of the vehicle; determining a driving state of the vehicle; and controlling at least a portion of a seat of the vehicle based on at least one of the sensed posture of the user or the driving state.

The sensing step according to one embodiment may further include determining whether the sensed posture corresponds to a stretching posture of the user.

When the sensed posture of the user is determined to be the stretching posture, the controlling step according to one embodiment may further include controlling an operation of the seat to support the user in performing a stretching movement.

The determining step according to one embodiment may include determining whether the driving state is a stopped state or a state prior to driving.

The controlling step according to one embodiment may include moving at least a portion of the seat when the driving state is the stopped state; and restoring the at least a portion of the seat to a previous position when the driving state is the state prior to driving.

### BRIEF DESCRIPTION OF THE DRAWINGS

FIG. 1 is a block diagram illustrating an apparatus for controlling a vehicle according to one embodiment.

FIG. 2 is a flowchart illustrating a method for controlling a vehicle according to one embodiment.

FIG. 3 is a view illustrating a flow of a method for controlling a vehicle according to one embodiment.

FIG. 4 is a view illustrating media playback and a provided screen according to one embodiment.

FIG. 5 is a view illustrating a screen provided in accordance with traffic light durations, according to one embodiment.

FIG. 6 is a view illustrating a method for controlling a vehicle according to one embodiment.

### DETAILED DESCRIPTION OF THE EMBODIMENTS

Hereinafter, exemplary embodiments of the present disclosure will be described in detail with reference to the accompanying drawings.

However, the spirit of the present disclosure is not limited to the embodiments described below, and the present disclosure may be embodied in various forms. One or more components of the embodiments may be selectively combined or substituted with one another without departing from the spirit or scope of the present disclosure.

In addition, the terminology used in the embodiments of the present disclosure, including technical and scientific terms, unless explicitly defined otherwise, will be interpreted as having meanings that are generally understood by those of ordinary skilled in the art to which the present disclosure pertains, and terms having meanings commonly understood, such as those defined in dictionaries, will be interpreted in the context of the related technologies.

In addition, the terminology used in the embodiments of the present disclosure is used for the purpose of describing the embodiments only and is not intended to limit the scope of the present disclosure.

In the present specification, the singular forms can be understood to include plural forms unless otherwise indicated, and the expression “at least one of A, B, and/or C” can be understood to include any combination of one or more A, B, and C.

In addition, expressions such as “first,” “second,” “A,” “B,” “(a),” and “(b),” may be used to describe components of embodiments of the present disclosure for convenience of description.

These expressions are used solely to distinguish one component from another, and do not limit the substance, order, or arrangement of the corresponding components.

Furthermore, when an component is described as being “connected,” “combined,” or “accessed” to another component, the description should be understood to include that the component is “connected,” “combined,” or “accessed” to the other component not only directly, but also indirectly through one or more intervening components.

In expression "formed or disposed “on (over) or under (below)” another component," the terms “on (over)” and “under (below)” include not only a direct contact between two components, but also formation or disposition in which one or more other components are interposed between the two components. Furthermore, the terms “on (over)” and “under (below)” may refer to both upper and lower directions relative to one component.

Hereinafter, embodiments of the present disclosure will be described in detail with reference to the accompanying drawings. The same reference numerals refer to the same or corresponding components throughout the drawings, and redundant descriptions thereof will be omitted.

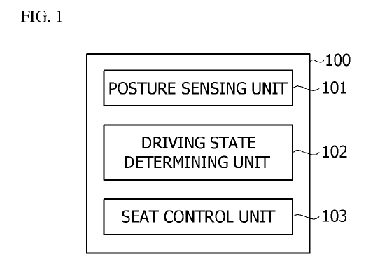

FIG. 1 is a block diagram illustrating an apparatus for controlling a vehicle according to one embodiment.

According to one embodiment, an apparatus for controlling a vehicle 100 may include a posture sensing unit 101 configured to sense a posture of a user of the vehicle, a driving state determining unit 102 configured to determine a driving state of the vehicle, and a seat control unit 103 configured to control at least a part of a seat of the vehicle based on the sensed posture of the user or the driving state.

According to one embodiment, components of the apparatus for controlling a vehicle may be configured by including at least a part of a vehicle, a camera, a sensor, a seat, a controller, a machine, a circuit, a semiconductor, a computing device, a memory, a processor, and a data transceiver, etc., wherein at least a part of each component may be mechanically, physically, communicatively, or electrically connected to at least a part of other components.

According to one embodiment, the apparatus for controlling a vehicle may include at least a part of all components described herein or shown in the drawings and may perform at least a part of all operations or functions described herein or shown in the drawings.

According to one embodiment, the apparatus for controlling a vehicle may output, display, or provide at least a part of all components described herein or shown in the drawings through a display, a user terminal, or administrator terminal, etc.

According to one embodiment, the posture sensing unit 101 may sense whether a sensed posture of the user is a stretching posture.

According to one embodiment, the posture sensing unit 101 may sense whether the sensed posture of the user is the stretching posture using or based on a captured video or a received signal (using a computer vision technology, etc.).

According to one embodiment, when the sensed posture of the user is the stretching posture, the seat control unit 103 may (automatically) control an operation of the seat such that the seat on which the user is positioned (automatically) supports stretching of the user.

According to one embodiment, the driving state determining unit 102 may determine whether the driving state of the vehicle is a stopped state or a state prior to driving.

According to one embodiment, the driving state determining unit 102 may determine whether the driving state is a stopped state or a state prior to driving based on or using a state of at least a part (e.g., a component of the vehicle, a GPS, a brake, an accelerator, a gear, etc.) of the vehicle.

According to one embodiment, the driving state determining unit 102 may determine whether the driving state is a stopped state or a state prior to driving based on or using a state of at least a part of driving or traffic signals (e.g., traffic lights, etc.) of a road on which the vehicle is positioned (at least a part of driving or traffic signals positioned in front of the vehicle) (by receiving traffic information or using a camera).

According to one embodiment, when the driving state of the vehicle is determined to be the stopped state, the seat control unit 103 may control an operation of the seat such that at least a part of the seat on which the user is positioned moves, or when the driving state of the vehicle is determined to be the state prior to driving, the seat control unit 103 may control an operation of the seat such that movement of at least a part of the seat on which the user is positioned is (automatically) restored.

According to an embodiment, the apparatus for controlling a vehicle may determine, through a camera, etc. within the vehicle, that the user, such as a driver, intends to stretch, and control at least a part of the vehicle (e.g., a seat mounted in the vehicle) (through a control signal or a control command) to secure space by movement of the seat such that the user may perform stretching.

According to one embodiment, the seat of the vehicle may be moved or adjusted using a component, such as a rail.

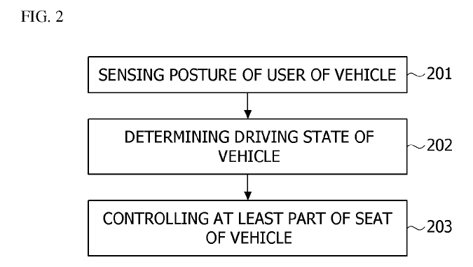

FIG. 2 is a flowchart illustrating a method for controlling a vehicle according to one embodiment.

According to one embodiment, each step of the method for controlling a vehicle may be performed by at least a part of the components of the apparatus for controlling a vehicle.

In step 201, the apparatus for controlling a vehicle may sense a posture of a user of the vehicle.

According to one embodiment, the apparatus for controlling a vehicle may sense whether the sensed posture of the user is a stretching posture.

In step 202, the apparatus for controlling a vehicle may determine a driving state of the vehicle.

According to one embodiment, the apparatus for controlling a vehicle may determine whether the driving state of the vehicle is a stopped state or a state prior to driving.

In step 203, the apparatus for controlling a vehicle may control at least a part of the seat of the vehicle based on the sensed posture of the user or the driving state.

According to one embodiment, when the sensed posture of the user is the stretching posture, the apparatus for controlling a vehicle may control an operation of the seat such that the seat on which the user is positioned supports stretching of the user.

According to one embodiment, when the sensed posture of the user is the stretching posture, the apparatus for controlling a vehicle may control an operation of the seat such that at least a part of a lower portion or an upper portion of the seat on which the user is positioned moves toward a rear of the vehicle or the user to support stretching of the user.

According to one embodiment, when the sensed posture of the user is not the stretching posture, or when it is determined that the stretching is finished, the apparatus for controlling a vehicle may control an operation of the seat such that at least a part of the lower portion or the upper portion of the seat on which the user is positioned moves toward a front of the vehicle or the user to support safety of the user.

According to one embodiment, when the driving state of the vehicle is determined to be the stopped state, the apparatus for controlling a vehicle may control an operation of the seat such that at least a part of the seat on which the user is positioned moves, or when the driving state of the vehicle is determined to be the state prior to driving, the apparatus for controlling a vehicle may control an operation of the seat such that movement of at least a part of the seat on which the user is positioned is restored (to a state prior to the stretching).

According to one embodiment, the apparatus for controlling a vehicle may determine, through a camera or a sensor mounted in the vehicle, that the user intends to stretch.

According to one embodiment, when a camera perceives or recognizes an occupant, who is the user of the vehicle, interlocking the fingers and fully extending the arms, the apparatus for controlling a vehicle may determine that the occupant intends to stretch.

According to one embodiment, the apparatus for controlling a vehicle may secure space or a seat shape so that the user may form a posture to sufficiently extend the legs and arms while stretching, and may observe through a camera and move the seat such that the user’s legs and arms do not contact an interior of the vehicle. In addition, when the vehicle is stopped by a traffic light while driving and a certain amount of time remains according to traffic light duration limits, the seat may automatically be restored.

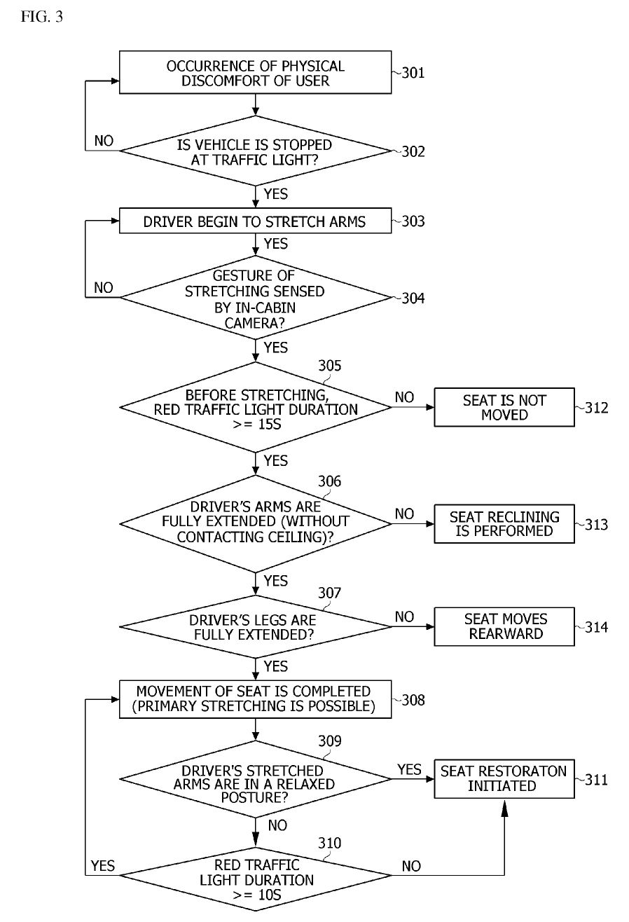

FIG. 3 is a view illustrating a flow of a method for controlling a vehicle according to one embodiment.

According to one embodiment, the apparatus for controlling a vehicle may control the seat through monitoring by an in-vehicle imaging device, such as an in-cabin camera, such that the user’s body (particularly the user’s arms) does not contact a ceiling of the vehicle, and may provide movement or control of the seat such that the user’s legs are not bent.

In step 301, the apparatus for controlling a vehicle may identify occurrence of physical discomfort in the user.

In step 302, the apparatus for controlling a vehicle may identify whether the vehicle is in a stopped state in front of, near, or in proximity to traffic lights.

In step 303, the apparatus for controlling a vehicle may identify, sense, or determine using various means (e.g., a sensor or a camera) that the user stretches (begins to stretch) at least a part of the body, such as the arms, inside the vehicle.

In step 304, the apparatus for controlling a vehicle may identify, using a camera, whether a stretching gesture is identified or sensed.

In step 305, prior to initiating (before movement of the seat in response to the stretching), the apparatus for controlling a vehicle may identify whether the duration of a traffic light, such as a red light, is a predetermined threshold (e.g., 15 seconds) or longer.

In step 306, the apparatus for controlling a vehicle may identify whether the user’s arms are fully extended (without contacting the ceiling of the vehicle) (through a captured video or a sensed signal).

In step 307, the apparatus for controlling a vehicle may identify whether the user’s legs are fully extended (through a captured video or a sensed signal).

In step 308, the apparatus for controlling a vehicle may control the seat of the vehicle such that at least a part of the seat is completely moved to a predetermined shape or position, or a shape or position to be determined (enabling primary stretching).

In step 309, the apparatus for controlling a vehicle may identify whether the stretched arms are in a relaxed posture.

In step 310, when the stretched arms are not in the relaxed posture, the apparatus for controlling a vehicle may identify whether the duration of a traffic light, such as a red light, is a predetermined threshold (e.g., 10 seconds) or longer.

In step 311, when the stretched arms are in the relaxed posture, the apparatus for controlling a vehicle may control the seat to initiate a restoration.

In step 312, prior to initiating, when the duration of a traffic light, such as a red light, is less than a predetermined threshold (e.g., 15 seconds), the apparatus for controlling a vehicle may control the seat not to move.

In step 313, when the user’s arms are fully extended, the apparatus for controlling a vehicle may control to perform seat reclining.

In step 314, when the user’s legs are not fully extended, the apparatus for controlling a vehicle may control the seat to move in a rear direction of the vehicle.

According to one embodiment, when the user’s legs are bent, the apparatus for controlling a vehicle may control the seat to move rearward (when it is predicted that the user’s legs will be bent based on interior space information or an estimated seated height of the occupant, the seat is controlled to move rearward).

According to one embodiment, when the user’s arms contact the ceiling of the vehicle and are bent, the apparatus for controlling a vehicle may provide or control a reclining angle of the seat to be more inclined.

According to one embodiment, when the user is an occupant other than a driver, the apparatus for controlling a vehicle may not consider a traffic light condition.

According to one embodiment, when the user performs a motion of lowering the arms after completing the stretching, the apparatus for controlling a vehicle may determine the user’s intention and control the seat to be restored to an original state.

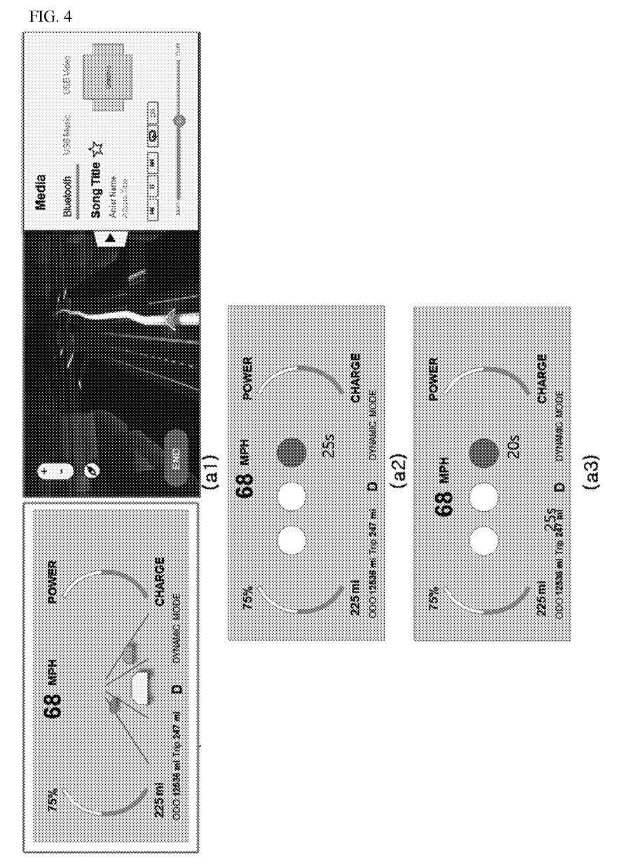

FIG. 4 is a view illustrating media playback and a provided screen according to one embodiment.

According to one embodiment, when it is observed that the user of the vehicle intends to stretch, the apparatus for controlling a vehicle may provide seat reclining and movement.

According to one embodiment, when the vehicle is in a stopped state by a signal from a traffic signal system, such as traffic lights, the apparatus for controlling a vehicle may control a degree of seat movement or reclining in consideration of the traffic light durations.

According to one embodiment, the apparatus for controlling a vehicle may play back music to facilitate stretching and may also control the seat to be moved or adjusted to facilitate stretching.

According to one embodiment, the apparatus for controlling a vehicle may control media (e.g., a sound, a video, an image, and a text) of a slow tempo to be played back or output as (user-set or recommended) music.

Referring to (a1) of FIG. 4, the apparatus for controlling a vehicle may recognize that the vehicle is stopped due to a traffic light.

Referring to (a2) of FIG. 4, the apparatus for controlling a vehicle may control the seat of the vehicle such that the stretching posture in which the user’s arms and legs are extended is possible since the traffic light is in a state of indicating or instructing a stop (e.g., a red light) (or since a remaining stop duration is 25 seconds or longer).

Referring to (a3) of FIG. 4, (since the remaining stop duration is 20 seconds or longer) the apparatus for controlling a vehicle may perform or control seat reclining by a camera so that the user may extend the body when stretching.

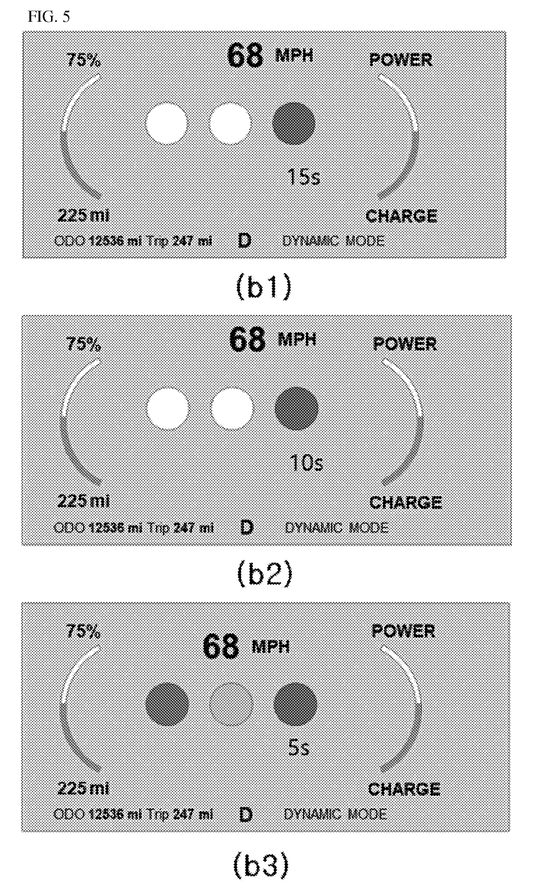

FIG. 5 is a view illustrating a screen provided in accordance with traffic light durations, according to one embodiment.

According to one embodiment, when a remaining stop duration of a traffic light is insufficient, the apparatus for controlling a vehicle may provide seat movement.

According to one embodiment, even when the stop duration of the traffic light remains, when a gesture of the user indicating a restoration from stretching is sensed by a camera, the apparatus for controlling a vehicle may control the seat to be restored to an original state.

Referring to (b1) of FIG. 5, the apparatus for controlling a vehicle may identify or calculate the stop duration of the traffic light, and the remaining stop duration is 15 seconds or longer, which the apparatus for controlling a vehicle may provide such that the user recognizes the 15 seconds.

Referring to (b2) of FIG. 5, in consideration of a time (e.g., 10 seconds) required for the seat of the vehicle to be restored to an original state, or when the user is in a relaxed posture after stretching, the apparatus for controlling a vehicle may control the seat to be restored to the original state.

Referring to (b3) of FIG. 5, when a traffic light is a signal indicating or instructing a change or driving such as a yellow or green light, or when such a signal is expected (e.g., when remaining stop duration is 5 seconds or longer and 10 seconds or shorter), the apparatus for controlling a vehicle may control the seat to be restored to an original, predetermined, or prior state.

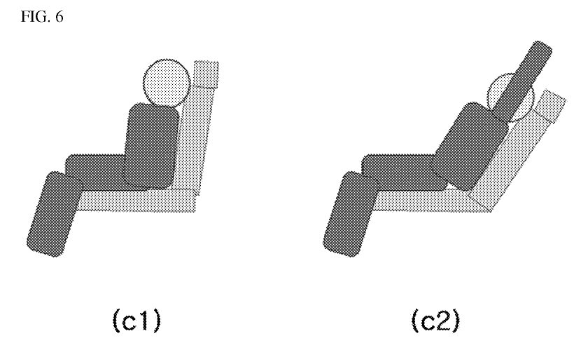

FIG. 6 is a view illustrating a method for controlling a vehicle according to one embodiment.

According to one embodiment, the apparatus for controlling a vehicle may identify whether a sufficient space is available for the user to fully extend the legs and control the seat (control the seat to move forward or rearward) and may identify or control seat reclining such that the arms may also be fully extended.

Referring to (c1) of FIG. 6, when the user of the vehicle is driving, or is in a state prior to or after stretching, the apparatus for controlling a vehicle may control the seat of the vehicle to move to or be fixed at a predetermined angle or position, and an angle of a lower portion of the seat that supports a lower portion of the user (e.g., the seat’s lower portion supporting the user’s buttocks) and an upper portion of the seat that supports an upper portion of the user (e.g., a seatback supporting the user’s back or waist, or a headrest supporting the user’s head) may approximately be 90 degrees.

According to one embodiment, when the user is a driver, the apparatus for controlling a vehicle may control the seat to move closer to a steering wheel of the vehicle or toward a front of the vehicle (to a predetermined position or to a position set based on the user’s physical condition).

Referring to (c2) of FIG. 6, when the user of the vehicle performs stretching, the apparatus for controlling a vehicle may control the seat of the vehicle to move to or be fixed at (by the user) a predetermined angle or position or at an angle or position to be determined, and the angle of the lower portion of the seat supporting the lower portion of the user and the upper portion of the seat supporting the upper portion of the user may be at least 90 degrees, and may approximately be 135 degrees or 180 degrees.

According to one embodiment, when the user is a driver, or when the user performs stretching while the vehicle is stopped, the apparatus for controlling a vehicle may control the seat to be spaced apart from the steering wheel of the vehicle or moved toward a rear of the vehicle (to a predetermined position or to a position set based on the user’s physical condition).

The term “unit,” as used in the embodiments of the present disclosure, refers to a software component or a hardware component, such as a field-programmable gate array (FPGA) or an ASIC, and performs a specific role. However, the term “unit” is not limited to software or hardware. A “unit” may be configured to reside in an addressable storage medium, or to run one or more processors. Accordingly, the “unit” may include, for example, software components, object-oriented software components, class components, task components, processors, functions, attributes, procedures, subroutines, segments of program code, drivers, firmware, microcode, circuits, databases, data structures, tables, arrays, or variables. Functions provided by components and “units” may be combined into a smaller number of components or “units,” or may be further separated into additional components and ‘units.” In addition, components and “units” may be configured to be implemented to run one or more CPUs within a device or within a secure multimedia card.

The foregoing description has been presented with reference to exemplary embodiments of the present disclosure. However, it will be understood by those of ordinary skilled in the art that various modifications and alterations may be made without departing from the spirit or scope of the present disclosure, as set forth in the appended claims.

What is claimed is:

1. An apparatus for controlling a vehicle, comprising:
a posture sensing unit configured to sense a posture of a user of the vehicle;
a driving state determining unit configured to determine a driving state of the vehicle; and
a seat control unit configured to control at least a portion of a seat of the vehicle based on at least one of the sensed posture of the user or the driving state.

2. The apparatus of claim 1, wherein the posture sensing unit is further configured to determine whether the sensed posture corresponds to a stretching posture of the user.

3. The apparatus of claim 2, wherein, when the sensed posture is determined to be the stretching posture, the seat control unit is configured to control an operation of the seat to support the user in performing a stretching movement.

4. The apparatus of claim 1, wherein the driving state determining unit is configured to determine whether the driving state is a stopped state or a state prior to driving.

5. The apparatus of claim 4, wherein, when the driving state is determined to be the stopped state, the seat control unit is configured to cause movement of at least a portion of the seat, and
wherein, when the driving state of the vehicle is determined to be the state prior to driving, the seat control unit is configured to restore the at least a portion of the seat to a previous position.

6. A method for controlling a vehicle, the method comprising:
sensing a posture of a user of the vehicle;
determining a driving state of the vehicle; and
controlling at least a portion of a seat of the vehicle based on at least one of the sensed posture of the user or the driving state.

7. The method of claim 6, wherein the sensing of the posture comprises determining whether the sensed posture corresponds to a stretching posture of the user.

8. The method of claim 7, wherein, when the sensed posture is determined to be the stretching posture, the controlling of the seat comprises adjusting the seat to support the user in performing a stretching movement.

9. The method of claim 6, wherein the determining of the driving state comprises determining whether the driving state is a stopped state or a state prior to driving.

10. The method of claim 9, wherein the controlling of the seat comprises: moving at least a portion of the seat when the driving state is the stopped state; and
restoring the at least a portion of the seat to a previous position when the driving state is the state prior to driving.
